(19) United States
(12) Patent Application Publication
(10) Pub. No.: US 2023/0358182 A1
(43) Pub. Date: Nov. 9, 2023

(54) Flap Device

(71) Applicant: Friedrich Boysen GmbH & Co. KG, Altensteig (DE)

(72) Inventors: Till RÖMHILD, Magstadt (DE); Michael EDLER, Haiterbach (DE); Markus MÜLLER, Gärtringen (DE); Nathanael WETZEL, Pfalzgrafenweiler (DE)

(21) Appl. No.: 18/141,670

(22) Filed: May 1, 2023

(30) Foreign Application Priority Data
May 4, 2022 (DE) 102022111038.9

(51) Int. Cl. F02D 9/10

(52) U.S. Cl. CPC F02D 9/1065

(57) ABSTRACT

A flap device for a motor vehicle comprises a flap housing that can be flowed through by a gas flow; a flap shaft that is rotatably supported about an axis of rotation in the flap housing and that supports a flap for blocking, directing or throttling the gas flow; and an actuating drive for rotating the flap shaft. The actuating drive is in a drive-effective connection with the flap shaft via a coupling, wherein the coupling comprises two separate coupling parts that can be axially plugged into one another and that, in the state plugged into one another, can be brought into engagement with one another in a form-fitting manner with respect to at least one direction of rotation, and wherein the coupling comprises a spring element that is inserted under an axial preload between the coupling parts plugged into one another, wherein the coupling parts have respective locking sections that, on an axial plugging into one another of the coupling parts, can be moved past one another and can be brought into an engaging-behind engagement with respect to at least one axial direction by a mutual rotation of the coupling parts plugged into one another with respect to the axis of rotation.

The invention relates to a flap device for a motor vehicle, in particular an exhaust gas flap device, comprising a flap housing that can be flowed through by a gas flow; a flap shaft that is rotatably supported about an axis of rotation in the flap housing and that supports a flap for blocking, directing or throttling the gas flow; and an actuating drive for rotating the flap shaft, wherein the actuating drive is in a drive-effective connection with the flap shaft via a coupling, wherein the coupling comprises two separate coupling parts that can be axially plugged into one another and that, in the state plugged into one another, can be brought into engagement with one another in a form-fitting manner with respect to at least one direction of rotation, and wherein the coupling comprises a spring element that is inserted under an axial preload between the coupling parts plugged into one another.

Such flap devices are, for example, used for selectively closing exhaust gas paths in exhaust gas systems of motor vehicles. By means of the actuating drive, for example an electric or pneumatic actuator, the flap or baffle plate can be rotated between a position releasing the exhaust gas flow and a position blocking the exhaust gas flow and can thus be positioned. Between the two positions mentioned, the flap throttles the exhaust gas flow. A partial or complete blocking of the exhaust gas flow can, for example, take place as part of the acoustic design of exhaust gas systems or for the intentional generation of a counter-pressure. Exhaust gas flaps can also be used in exhaust gas return systems for the reduction of nitrogen oxide within the engine, e.g. in order to intentionally apply a certain quantity of exhaust gas to a low-pressure path at the fresh air side of an internal combustion engine.

A problem with flap devices of the mentioned kind is in particular the heat transfer from the flap via the coupling to the actuating drive that could be damaged by overheating.

An unwanted heat transfer from the flap to the actuating drive can in particular take place by radiation. Shielding elements for reducing the radiation transmission, such as sheet metal heat protection plates, often cannot be effectively used since they may not block the coupling parts to be plugged into one another during the assembly of the flap device and therefore have to be provided with correspondingly large openings. The large openings also reduce the usable contact surface of a sheet metal heat protection plate when it is used, e.g. in the form of a trough, for holding the actuating drive.

It is an object of the invention to improve the protection of the actuating drive against a thermal overload in flap devices of the above-mentioned kind and to provide extended possibilities for holding the actuating drive.

The object is satisfied by a flap device having the features of claim 1.

In accordance with the invention, the coupling parts have respective locking sections that, on an axial plugging into one another of the coupling parts, can be moved past one another and can be brought into an engaging-behind engagement with respect to at least one axial direction by a mutual rotation of the coupling parts plugged into one another with respect to the axis of rotation.

Due to the engaging-behind engagement of the locking sections, the coupling parts are held together in the state plugged into one another, even if they are acted on by the spring element facing axially away from one another. This means that the coupling parts remain together even on an axial preload of the spring element. Therefore, it is possible to perform a preassembly of the coupling and to attach the actuating drive, including any holders, shields and possibly other or further components, to the flap housing only after this preassembly. This means that it is, for example, possible to mount the coupling without the associated actuating unit. This is advantageous in that no large openings have to be present at the shielding components for the leading through of one coupling part or both coupling parts.

In a flap device in accordance with the invention, the coupling parts can be secured against an unwanted separation in a simple manner, in particular similarly to in a bayonet fastening.

An axial direction, a radial direction and a tangential direction or a peripheral direction are defined by the axis of rotation.

The coupling parts can have respective axial support sections which the spring element contacts. The axial support sections preferably extend in the radial direction.

Provision can be made that the spring element preloads the coupling parts against one another in a tangential direction. This ensures a torque transmission without play and thus a reduced noise formation on the actuation of the flap. Depending on the application, the torque transmission can take place via the locking sections and/or via separate entrainer sections of the coupling parts. A further advantage of the preload of the coupling parts in the tangential direction is that a self-locking can hereby be ensured. Accordingly, the tangential preload is preferably selected such that the coupling parts are automatically locked via the slotted part on a plugging together.

In accordance with an embodiment of the invention, one of the coupling parts is a flap-side coupling part and the other coupling part is a drive-side coupling part, with the flap-side coupling part being fixedly connected to the flap shaft and/or the drive-side coupling part being configured for a releasable connection to an output shaft of the actuating drive. Due to the releasable connection, the actuating drive can be non-destructively dismantled if required. The output shaft does not necessarily have to be the motor shaft of a motor of the actuating drive. For example, the actuating drive can comprise a gear whose output element forms the output shaft.

The drive-side coupling part can be couplable to an output shaft of the actuating drive by means of a plug-in connection. A plug-in connection is particularly simple.

A specific embodiment of the invention provides that the drive-side coupling part has at least one recess into which a plug-in projection arranged at the output shaft of the actuating drive can be plugged. Depending on the embodiment, the plug-in projection plugged into the recess can provide a form fit and/or a friction locking. Radial design features for a form fit can in particular be provided at the plug-in projection and at the recess.

In accordance with a further embodiment of the invention, the drive-side coupling part has an arrangement of at least two recesses, preferably four recesses, into which respective plug-in projections arranged at the output shaft of the actuating drive can be plugged. A form-fitting connection between the coupling parts can thereby be established in a particularly simple manner.

The recesses can define a rotationally symmetrical pattern to enable a plugging in of the output shaft in different rotational positions and, accordingly, an attachment of the actuating drive in different orientations. The flap device can thus be flexibly adapted to different installation space specifications. The pattern can in particular be rotationally symmetrical with respect to a passing through of the axis of rotation by the drive-side coupling part. For example, the recesses can define a cloverleaf-like pattern.

The actuating drive can have an elongated housing. With such an actuating drive, it is of particular advantage that there is a possibility for an assembly in different orientations.

Provision can be made that the or each plug-in projection has a cone. The form fit is thereby improved and a torque transmission without play is in particular made possible.

A further embodiment of the invention provides that one of the coupling parts has an axial projection extending in an axial direction as a locking section and the other coupling part has a radial projection extending in a radial direction as a locking section, with a contact surface extending in a tangential direction for the radial projection being formed at the axial projection. The tangential contact surface can engage behind the radial projection and can thus bring about the axial locking of the coupling parts. The spring element can ensure, through a torsional stress, that the axial projection is pressed tangentially against the radial projection. Alternatively or additionally, the spring element could ensure, at least in a preassembled state, that the radial projection is pressed axially against the contact surface.

The contact surface is preferably arranged in a region of the axial projection that is a central region with respect to the axial direction. A movement play for the radial projection thereby exists in front of and after the contact surface. This movement play facilitates an axial preloading of the spring element and enables a compensation of assembly tolerances.

In accordance with a further embodiment of the invention, a run-on slope is formed at the axial projection, along which run-on slope the radial projection can slide on a plugging of the coupling parts into one another. This facilitates the assembly. Due to the run-on slope, the radial projection is automatically moved into a rotational position on a plugging together of the coupling parts, in which rotational position the radial projection can move past the contact surface to then rotate back and enter into an engagement with the contact surface.

Adjacent to the axial projection, a further projection can be provided at the respective coupling part so that a receiving gap or receiving slot for the radial projection is formed. The radial projection is then tangentially engaged behind at both sides in the assembled state of the coupling.

The actuating drive is preferably fastened to the flap housing by means of a holder that has a leadthrough for an output shaft of the actuating drive. The holder provides a thermal shielding of the actuating drive and facilitates the assembly. The holder is preferably formed from at least one heat-resistant metal sheet.

The leadthrough can have a passage surface that is smaller than an axial cross-sectional surface of the coupling, in particular of the coupling parts. The smaller the leadthrough, the more effective the protection of the actuating drive against heat radiation or heat flow. Accordingly, it is preferred that the passage surface is just sufficient for a frictionless passage of the output shaft. Such a small leadthrough would not be possible if the coupling parts had to be plugged together only after the attachment of the holder or if the coupling as a whole had to be connected to the flap shaft only after the attachment of the holder. Due to the locking sections, the coupling can, however, be installed at the flap side in the plugged-together state before the leadthrough of the shielding holder is fastened to the flap housing.

The coupling parts are preferably designed as simple stamped/bent parts. The locking sections can in particular be designed as bent-over metal strips. The coupling parts can generally also be designed as cast parts, pressure parts, powder injection molded parts (Metal Injection Molding, MIM) or the like.

In accordance with a further embodiment of the invention, at least one component of the actuating drive, in particular a housing of the actuating drive and/or an output shaft of the actuating drive, is at least partly produced from plastic. A weight saving thereby results. The use of plastic components is in particular made possible by the improved heat protection which a holder having a relatively small leadthrough provides.

Further developments of the invention can also be seen from the dependent claims, from the description, and from the enclosed drawings.

The invention will be described in the following by way of example with reference to the enclosed drawings.

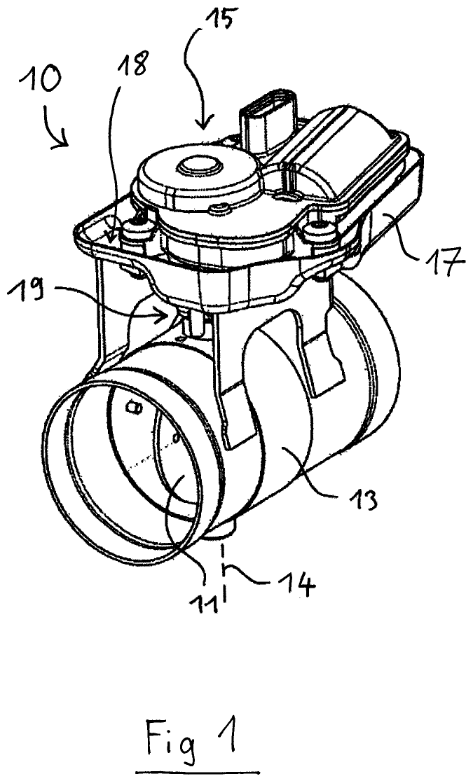

FIG. 1 shows a perspective representation of a flap device in accordance with the invention;

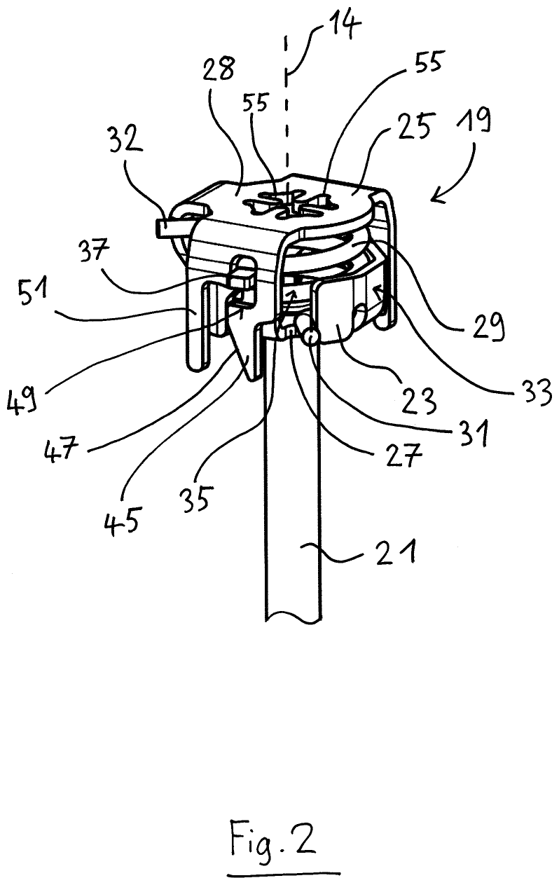

FIG. 2 shows a coupling of the flap device in accordance with FIG. 1 in a perspective representation;

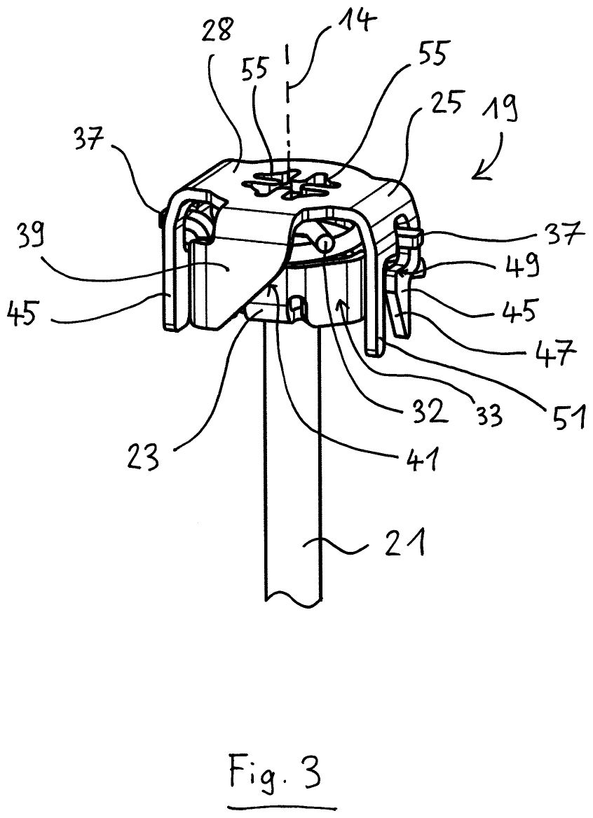

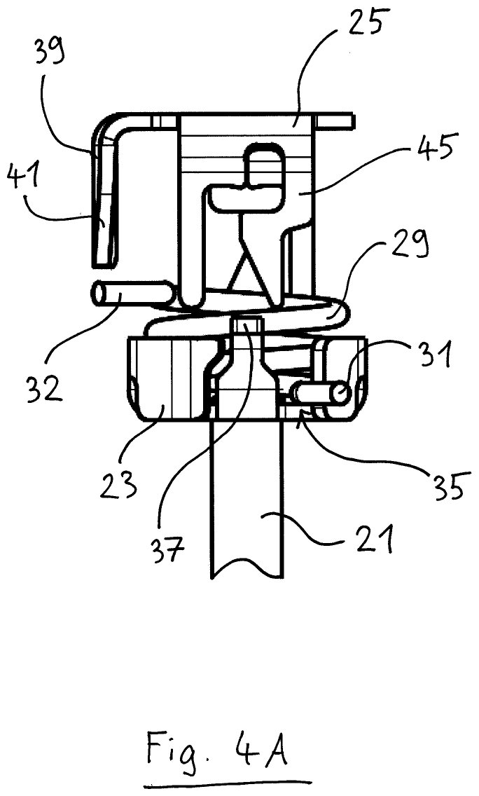

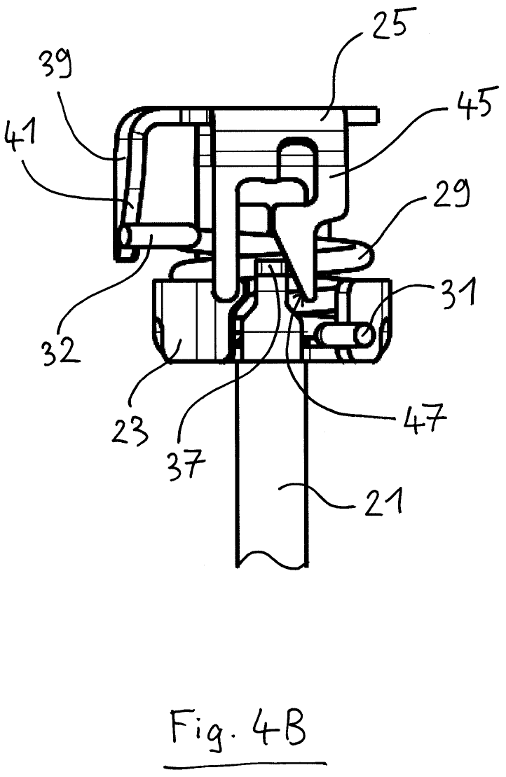

FIG. 3 shows the coupling in accordance with FIG. 2 from a different viewing direction; and

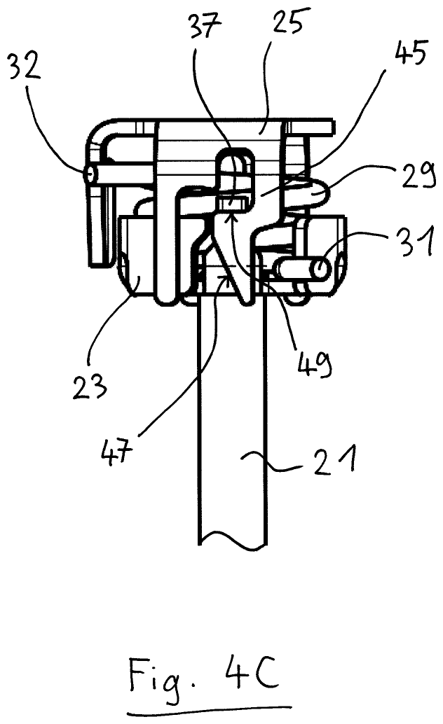

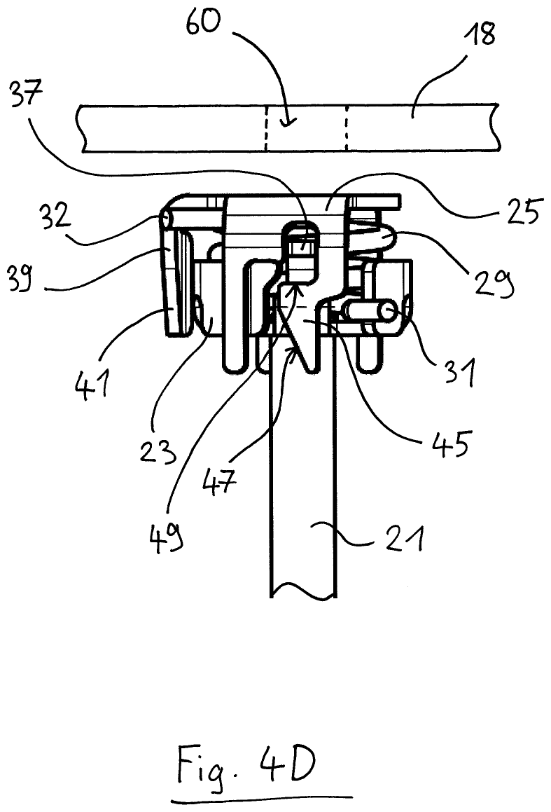

FIGS. 4A-4D show the coupling in accordance with FIG. 2 at various stages during the assembly.

The flap device 10 shown in FIG. 1 comprises a flap 11, which is rotatably supported about an axis of rotation 14 in a flap housing 13, and an electric actuator as an actuating drive 15 for rotating the flap 11. The flap 11 is designed such that it blocks, throttles or releases a gas flow guided through the flap housing 13 depending on the rotational position. In the embodiment shown, the flap housing 13 is of a tubular design. The flap device 10 can in particular be configured as an exhaust flap device for the exhaust train of a motor vehicle.

The actuating drive 15 is fastened to the flap housing 13 by means of a holder 17. A base surface 18 of the holder 17 located between the actuating drive 15 and the flap housing 13 here effects a thermal shielding of the actuating drive 15 from the flap housing 13. The flap housing 13 and the holder 17 are preferably produced from a heat-resistant metal.

An output shaft of the actuating drive 15, which is not visible in FIG. 1 and is guided by the base surface 18 of the holder 17, transmits a torque to a flap shaft 21 connected to the flap 11 by means of a coupling 19 shown in more detail in FIGS. 2 and 3.

The coupling 19 comprises a flap-side coupling part 23 that is rotationally fixedly connected to the flap shaft 21, for example welded thereto. Furthermore, the coupling 19 comprises a drive-side coupling part 25. The two coupling parts 23, 25 are produced from sheet metal as stamped/bent parts and have respective plate-like support sections 27, 28 that extend transversely to the flap shaft 21. A helical spring 29 is arranged between the two coupling parts 23, 25 and is supported in the axial direction at the support sections 27, 28. The helical spring 29 has two limbs 31, 32 which can be pivoted relative to one another and by means of which the helical spring 29 can be elastically twisted.

The flap-side coupling part 23 has a wall section 33 that projects from the periphery of the support section 27 in the axial direction and, together with the support section 27, forms a cup-like receiver for the helical spring 29. A recess 35 through which a first limb 31 of the helical spring 29 is guided, as shown, is formed in the wall section 33. The flap-side coupling part 23 further has two mutually oppositely disposed radial projections 37 (FIG. 3) that project in the radial direction from the wall section 33.

The drive-side coupling part 25 has a holding projection 39 that projects from the periphery of the support section 28 in the axial direction. As can be seen in FIG. 3, a limb run-on slope 41 is provided at the holding projection 39. The second limb 32 of the helical spring 29 is supported at the holding projection 39 in the tangential direction.

Furthermore, two axial projections 45 are provided at the drive-side coupling part and extend from the periphery of the support section 28 in the axial direction. In the embodiment shown, the axial projections 45 are arranged radially in opposite directions. A radial projection run-on slope 47 is formed at each of the axial projections 45. Viewed in an axial direction facing away from the flap 11 (FIG. 1), behind the radial projection run-on slopes 47, respective steps are formed at the axial projections 45 that form contact surfaces 49 extending in the tangential direction for the radial projections 37. Tangentially adjacent to the axial projections 45, additional axial projections 51 extend from the support section 28 in the axial direction.

The support section 28 of the drive-side coupling part 25 has an arrangement of four recesses 55 into which respective plug-in projections arranged at the output shaft, not shown, of the actuating drive 15 can be plugged. The recesses 55 define a rotationally symmetrical pattern, here by way of example a cloverleaf-like pattern. By means of the recesses 55 and the associated plug-in projections, the drive-side coupling part 25 can be releasably coupled to the output shaft of the actuating drive 15.

The assembly of the coupling 19 will be described in the following with further reference to FIGS. 4A-4D. First, the coupling parts 23, 25 are separated from one another (FIG. 4A). The flap-side coupling part 23 is already fastened to the flap shaft 21, while the drive-side coupling part 25 is not yet connected to the actuating drive 15, i.e. is loose. The helical spring 29 is inserted into the cup-like receiver formed at the flap-side coupling part 23, and indeed such that the first limb 31 engages into the recess 35 and is thus fixedly held.

Then, the drive-side coupling part 25 is moved in the axial direction toward the flap-side coupling part 23, wherein the second limb 32 of the helical spring 29 enters into contact with the limb run-on slope 41 and the radial projections 37 enter into contact with the radial projection run-on slopes 47 (FIG. 4B). During a subsequent plugging together of the coupling parts 23, 25, the radial projections 37 slide along the radial projection run-on slopes 47. Equally, the second limb 32 of the helical spring 29 slides along the limb run-on slope 41. The second limb 32 is hereby rotated with respect to the fixedly held first limb 31. The helical spring 29 is thus twisted and preloads the drive-side coupling part 25 relative to the flap-side coupling part 23 in the tangential direction.

On a further axial movement of the drive-side coupling part 25, the radial projections 37 acted on by the torsional stress snap into the respective free spaces behind the radial projection run-on slopes 47 (FIG. 4C). The drive-side coupling part 25 is now securely held at the flap-side coupling part 23 since the radial projections 37 are engaged behind in the axial direction by the contact surfaces 49. Thus, the axial projections 45 and the radial projections 37 that can be brought into engagement therewith form locking sections that can be moved past one another on an axial plugging into one another of the coupling parts 23, 25 and that can be brought into a form-fitting engagement by a mutual rotation of the coupling parts 23, 25 plugged into one another.

The drive-side coupling part 25 can thus be released to mount the flap shaft 21 together with the coupling 19 at the flap housing 13 (FIG. 1). After the assembly of the flap shaft 21 and the coupling 19, the holder 17 is fastened to the flap housing 21.

Finally, the actuating drive 15 is attached to the holder 17, wherein the output shaft or a transmission component rotationally fixedly connected thereto are guided through a leadthrough 60 of the base surface 18 of the holder 17 shown in FIG. 4D and are plugged onto the drive-side coupling part 25. Here, the preferably conical plug-in projections enter the recesses 55 (FIG. 2) and provide a friction-locked and form-fitting connection of the output shaft to the drive-side coupling part 25. In the course of this plug-in process, the helical spring 29 is clamped between the two support sections 27, 28 and is thus axially pressed together, wherein the radial projections 37 move away from the contact surfaces 49 (FIG. 4D).

In the end position, the helical spring 29 is therefore preloaded both axially and tangentially. The tangential preload in this respect has the effect that the radial projections 37 are pressed against respective flanks of the axial projections 45. Such a small-area contact supports a thermal decoupling of the two coupling parts 23, 25 and furthermore eliminates a noise-generating play.

The thermal shielding of the actuating drive 15 is improved in that the leadthrough 60 is just large enough for the output shaft. If the drive-side coupling part 25 or the entire coupling 19 were preassembled at the actuating drive 15, the leadthrough 60 would, in contrast, have to be large enough for the much larger cross-sectional surface of the drive-side coupling part 25. It has been shown that in a flap device 10 in accordance with the invention, due to the improved thermal shielding, one or more components of the actuating drive 15 can be produced from plastic, which enables a considerable reduction in the weight and the manufacturing costs.

It is understood that, at the coupling parts 23, 25, differently designed locking sections can also be provided that can be moved past one another on an axial plugging into one another of the coupling parts 23, 25 and that can be brought into an engaging-behind engagement with respect to at least one axial direction by a mutual rotation of the coupling parts 23, 25 plugged into one another with respect to the axis of rotation 14. For example, stepped grooves and pins or brackets moving into them could be provided as locking sections.

### REFERENCE NUMERAL LIST

10 flap device
11 flap
13 flap housing
14 axis of rotation
15 actuating drive
17 holder
18 base surface
19 coupling
21 flap shaft
23 flap-side coupling part
25 drive-side coupling part
27 support section
28 support section
29 helical spring
31 first limb
32 second limb
33 wall section
35 recess
37 radial projection
39 holding projection
41 limb run-on slope
45 axial projection
47 radial projection run-on slope
49 contact surface
51 additional axial projection
55 recess
60 leadthrough

1. A flap device for a motor vehicle, said flap device comprising a flap housing that can be flowed through by a gas flow; a flap shaft that is rotatably supported about an axis of rotation in the flap housing and that supports a flap for blocking, directing or throttling the gas flow; and an actuating drive for rotating the flap shaft, wherein the actuating drive is in a drive-effective connection with the flap shaft via a coupling, wherein the coupling comprises two separate coupling parts that can be axially plugged into one another and that, in the state plugged into one another, can be brought into engagement with one another in a form-fitting manner with respect to at least one direction of rotation, and wherein the coupling comprises a spring element that is inserted under an axial preload between the coupling parts plugged into one another, and
wherein the coupling parts have respective locking sections that, on an axial plugging into one another of the coupling parts, can be moved past one another and can be brought into an engaging-behind engagement with respect to at least one axial direction by a mutual rotation of the coupling parts plugged into one another with respect to the axis of rotation.

2. The flap device in accordance with claim 1, wherein the flap device is an exhaust gas flap device.

3. The flap device in accordance with claim 1,
wherein the spring element preloads the coupling parts against one another in a tangential direction.

4. The flap device in accordance with claim 1,
wherein one of the coupling parts is a flap-side coupling part and the other coupling part is a drive-side coupling part, with the flap-side coupling part being fixedly connected to the flap shaft and/or the drive-side coupling part being configured for a releasable connection to an output shaft of the actuating drive.

5. The flap device in accordance with claim 4,
wherein the drive-side coupling part can be coupled to an output shaft of the actuating drive by means of a plug-in connection.

6. The flap device in accordance with claim 5,
wherein the drive-side coupling part has at least one recess into which a plug-in projection arranged at the output shaft of the actuating drive can be plugged.

7. The flap device in accordance with claim 6,
wherein the drive-side coupling part has an arrangement of at least two recesses into which respective plug-in projections arranged at the output shaft of the actuating drive can be plugged.

8. The flap device in accordance with claim 7,
wherein the drive-side coupling part has an arrangement of four recesses.

9. The flap device in accordance with claim 7,
wherein the recesses define a rotationally symmetrical pattern.

10. The flap device in accordance with claim 6,
wherein the or each plug-in projection has a cone.

11. The flap device in accordance with claim 1,
wherein one of the coupling parts has an axial projection extending in an axial direction as a locking section and the other coupling part has a radial projection extending in a radial direction as a locking section, with a contact surface extending in a tangential direction for the radial projection being formed at the axial projection.

12. The flap device in accordance with claim 11,
wherein the contact surface is arranged in a region of the axial projection that is a central region with respect to the axial direction.

13. The flap device in accordance with claim 11,
wherein a run-on slope is formed at the axial projection, along which run-on slope the radial projection can slide on a plugging of the coupling parts into one another.

14. The flap device in accordance with claim 1,
wherein the actuating drive is fastened to the flap housing by means of a holder that has a leadthrough for an output shaft of the actuating drive.

15. The flap device in accordance with claim 14,
wherein the leadthrough has a passage surface that is smaller than an axial cross-sectional surface of the coupling.

16. The flap device in accordance with claim 14,
wherein the leadthrough has a passage surface that is smaller than an axial cross-sectional surface of the coupling parts.

17. The flap device in accordance with claim 1,
wherein the coupling parts are designed as stamped/bent parts.

18. The flap device in accordance with claim 1,
wherein at least one component of the actuating drive is at least partly produced from plastic.

19. The flap device in accordance with claim 18,
wherein the at least one component of the actuating drive comprises a housing of the actuating drive and/or an output shaft of the actuating drive.
